(19) United States
(12) Patent Application Publication
(10) Pub. No.: US 2024/0067841 A1
(43) Pub. Date: Feb. 29, 2024

(54) ADDITIVES FOR WATER-BASED WOOD STAINS

(71) Applicants: Shan Jiang et al., Ames, IA (US); Yifan Li, Ames, IA (US); Rebecca Jane Mort, Ames, IA (US)

(72) Inventors: Shan Jiang et al., Ames, IA (US); Yifan Li, Ames, IA (US); Rebecca Jane Mort, Ames, IA (US)

(21) Appl. No.: 18/447,048

(22) Filed: Aug. 9, 2023

Related U.S. Application Data
(60) Provisional application No. 63/373,904, filed on Aug. 30, 2022.

(51) Int. Cl. C09D 15/00; C08F 212/08; C09D 7/40; C09D 7/45; C09D 7/65

(52) U.S. Cl. CPC C09D 15/00; C08F 212/08; C09D 7/45; C09D 7/65; C09D 7/67; C09D 7/68; C09D 7/69

(57) ABSTRACT

An additive for a water-based wood stain includes a polymeric particle including a polymer that includes a repeating unit formed from a compound having the formula X-L¹-A, wherein X is a substituted or unsubstituted (C₂-C₈)alkenyl containing one or more carbon-carbon double bonds, L¹ is a bond, —C(O)—O—, —O—C(O)—, or a substituted or unsubstituted (C₁-C₁₀)alkylene interrupted by 0, 1, 2, or 3 heteroatoms chosen from O and NR¹ wherein R¹ is —H or (C₁-C₅)alkyl, and A is —H, substituted or unsubstituted (C₁-C₂₀)hydrocarbyl, or substituted or unsubstituted phenyl. The polymeric particle has a particle size in solution of 10 nm to 2000 nm.

### CROSS-REFERENCE TO RELATED APPLICATION

This application claims the benefit of priority to U.S. Provisional Patent Application Ser. No. 63/373,904 filed Aug. 30, 2022, the disclosure of which is incorporated herein in its entirety by reference.

### BACKGROUND

Wood stain enhances the beauty of bare wood surfaces with intense color. It is mostly for use on bare, interior wood surfaces or surfaces from which the previous finish has been removed. They are fast drying, semi-transparent, and clean-up easily with soap and water. Among broad categories of wood stains, water-based stains have several superior qualities over oil-based stains. Water-based stains have high-quality pigments that produce rich, dark, colors on hard-to-stain woods like maple and pine. Due to the environmentally-friendly aqueous solvent, they also have low odor, low VOC, can be cleaned-up with water, and are nonflammable.

However, one of the long existing and biggest challenges hindering the complete replacement of oil-based stains with water-based products is tendency of water-based stains to leave noticeable lapping lines. When the end user applies multiple layers of a water-based stain, there is a significant color mismatch between regions with one layer versus two layers or more. This issue becomes most severe for do-it-yourself users, since it is often a difficult task to make the stain appear even and smooth. The appearance is the one of most important criteria in determining the quality of a stain. Oil-based wood stains can produce an even and smooth finish even with multiple touch-ups hours after application. However, for waterborne wood stains, touch-ups after ten minutes will show up noticeable color differences. The poor lapping performance of water-based wood stains has significantly limited their adoption and market share.

### SUMMARY OF THE INVENTION

Various aspects of the present invention provide an additive for a water-based wood stain. The additive includes a polymeric particle including a polymer that includes a repeating unit formed from a compound having the formula X-L¹-A, wherein X is a substituted or unsubstituted (C₂-C₅)alkenyl containing one or more carbon-carbon double bonds, L¹ is a bond, —C(O)—O—, —O—C(O)—, or a substituted or unsubstituted (C₁-C₁₀)alkylene interrupted by 0, 1, 2, or 3 heteroatoms chosen from O and NR¹ wherein R¹ is —H or (C₁-C₅)alkyl, and A is —H, substituted or unsubstituted (C₁-C₂₀)hydrocarbyl, or substituted or unsubstituted phenyl. The polymeric particle has a particle size in solution of 10 nm to 2000 nm. Various aspects of the present invention provide a cured and/or dried product of the additive. Various aspects of the present invention provide a water-based wood stain including the additive.

Various aspects of the present invention provide an additive for a wood-based wood stain. The additive includes a polymeric particle comprising a polymer that comprises a repeating unit formed from styrene. The polymeric particle has a particle size in solution of 10 nm to 2000 nm.

Various aspects of the present invention provide an additive for a water-based wood stain. The additive includes a polymeric particle including a polymer that is poly(styrene-co-(methyl methacrylate)), poly(styrene-co-methacrylate), poly(styrene-co-(butyl acrylate)), poly(styrene-co-(tert-butyl acrylate)), or poly(styrene-co-(vinyl alcohol)). The polymeric particle has a particle size in solution of 10 nm to 2000 nm.

Various aspects of the present invention provide an additive for a water-based wood stain. The additive includes a polymeric particle including a polymer. The polymer includes a hydrophilic lobe and crosslinked polymeric hydrophobic lobe. The hydrophilic lobe includes a repeating unit formed from styrene, and a repeating unit formed from a compound having the formula Y-L²-C(O)—O—B or Y-L²-O—C(O)—B, wherein Y is a substituted or unsubstituted (C₂-C₈)alkenyl containing one or more carbon-carbon double bonds, L² is a bond or a substituted or unsubstituted (C₁-C₁₀)alkylene interrupted by 0, 1, 2, or 3 heteroatoms chosen from O and NR¹ wherein R¹ is —H or (C₁-C₅)alkyl, and B is —H or a substituted or unsubstituted (C₁-C₂₀)hydrocarbyl. The crosslinked polymeric hydrophobic lobe is connected to the polymer in place of the B in the —C(O)—O—B structure or in place of the —C(O)—B in the —O—C(O)—B structure. The hydrophobic lobe includes repeating units formed from one or more acrylate esters. The polymeric particle has a particle size in solution of 10 nm to 2000 nm.

Various aspects of the present invention provide a water-based stain. The water-based stain includes a water-based binder. The water based stain also includes an additive that includes a polymeric particle including a polymer that includes a repeating unit formed from a compound having the formula X-L¹-A, wherein X is a substituted or unsubstituted (C₂-C₈)alkenyl containing one or more carbon-carbon double bonds, L¹ is a bond, —C(O)—O—, —O—C(O)—, or a substituted or unsubstituted (C₁-C₁₀)alkylene interrupted by 0, 1, 2, or 3 heteroatoms chosen from O and NR¹ wherein R¹ is —H or (C₁-C₅)alkyl, and A is —H, substituted or unsubstituted (C₁-C₂₀)hydrocarbyl, or substituted or unsubstituted phenyl. The polymeric particle has a particle size in solution of 10 nm to 2000 nm. The polymeric particles have a concentration in the water-based stain of 1 wt % to 30 wt %.

Various aspects of the present invention provide a method of making a water-based stain. The method includes combining the additive and a base water-based stain to form the water-based wood stain.

Various aspects of the present invention provide a method of making an additive for a water-based wood stain. The method includes heating a reaction mixture to form the additive. The reaction mixture includes a free-radical initiator and at least one monomer including a vinyl group.

Various aspects of the present invention provide a method of making an additive for a water-based wood stain. The method includes heating a reaction mixture to form the additive. The reaction mixture includes a free-radical initiator and at least one monomer including a vinyl group. The heating includes titrating an additional portion of the free-radical initiator into the reaction mixture, titrating an additional portion of the at least one monomer including a vinyl group into the reaction mixture, or a combination thereof. The additive has a particle size of 10 nm to 100 nm.

Various aspects of the present invention provide an article that includes wood. The wood includes the water-based stain of the present invention that includes the additive of the present invention, or a dried and/or cured product of the water-based stain.

Various aspects of the present invention provide a method of using the additive of the present invention. The method includes combining the additive with a water-based stain.

Various aspects of the present invention provide a method of using a water-based wood stain that includes the additive of the present invention. The method includes applying the water-based stain to wood.

Various aspects of the water-based stain additive of the present invention and water-based stains including the same have certain advantages over other water-based stains. For example, in various aspects, water-based stains including the polymeric particle additive of the present invention have reduced visible lapping as compared to the same water-based stain without the polymeric particle additive, or have no visible lapping, even after long drying periods between repeated coatings. In various aspects, the polymeric particle additive of the present invention can be incorporated into a water-based stain using current wood stain mixing technology that is already in use in the wood stain industry. In various aspects, water-based stains including the polymeric particle additive of the present invention provide decreased surface roughness and/or decreased wood grain raise, as compared to the same wood surface coated with the same water-based stain but without the polymeric particle additive. In various aspects, water-based stains including the polymeric particle additive of the present invention provide an action of applying the water-based wood stain to a wood surface that feels smoother to the user applying the stain, as compared to the smoothness of action of applying the same water-based stain to the same wood surface but without the polymeric particle additive. In various aspects of the present invention, the additive can have a smaller particle size in solution than other additives for water-based stains.

In various aspects, water-based stains including the polymeric particle additive of the present invention can show reduced or eliminated lapping at low concentrations of the additive, such as at concentrations of 2 wt % to 5 wt %, or less than 2 wt %. In various aspects, a water-based stain including the polymeric particle additive of the present invention can be conveniently prepared via pre-addition (e.g., addition during the stain formulation process) or post-addition (e.g., addition by the stain user after purchase of the water-based stain).

### BRIEF DESCRIPTION OF THE FIGURES

The patent or application file contains at least one drawing executed in color. Copies of this patent or patent application publication with color drawing(s) will be provided by the Office upon request and payment of the necessary fee.

The drawings illustrate generally, by way of example, but not by way of limitation, various aspects of the present invention.

FIG. 1 illustrates a photograph of an aqueous suspension of polymeric particles, in accordance with various aspects of the present disclosure.

FIG. 2A illustrates an over-lapping test for waterborne wood stain post-added with different amount of 200 nm Janus particle additives, in accordance with various aspects of the present disclosure.

FIG. 2B illustrates an over-lapping test for waterborne wood stain post-added with different amount of 400 nm Janus particle additives, in accordance with various aspects of the present disclosure.

FIG. 2C illustrates an over-lapping test for water-based wood stain post-added with different amount of 800 nm Janus particle additives, in accordance with various aspects of the present disclosure.

FIG. 3A illustrates an over-lapping test for waterborne wood stain post-added with different amount of 200 nm polystyrene additive, in accordance with various aspects of the present disclosure.

FIG. 3B illustrates an over-lapping test for waterborne wood stain post-added with different amount of 400 nm polystyrene particle additive, in accordance with various aspects of the present disclosure.

FIG. 3C illustrates an over-lapping test for water-based wood stain post-added with different amount of 1500 nm Polystyrene particle additive, in accordance with various aspects of the present disclosure.

FIG. 4A-F illustrates overlapping tests for various water-based stains including polystyrene particle additives on different types of wood, in accordance with various aspects of the present disclosure.

FIG. 5A-F illustrates over-lapping tests for various water-based stains including polystyrene particle additives on different types of wood, in accordance with various aspects of the present disclosure

FIGS. 6A-E illustrate over-lapping tests for water-based wood stains including various additives, in accordance with various aspects of the present disclosure.

FIGS. 7A-E illustrate over-lapping tests for water-based wood stains including various additives, in accordance with various aspects of the present disclosure.

FIGS. 8A-D illustrate over-lapping tests for water-based stains including various amounts of additives, in accordance with various aspects of the present disclosure.

FIGS. 9A-D illustrate over-lapping tests for water-based wood stains including additives having various particle sizes, in accordance with various aspects of the present disclosure.

FIGS. 10A-D illustrate over-lapping tests for water-based wood stains including additives having various particle sizes, in accordance with various aspects of the present disclosure.

FIGS. 11A-D illustrate over-lapping tests for water-based wood stains including various additives, in accordance with various aspects of the present disclosure.

FIGS. 12A-F illustrate over-lapping tests for various water-based stains including various additives, in accordance with various aspects of the present disclosure.

FIGS. 13A-B illustrate over-lapping tests for various water-based stains including various additives, in accordance with various aspects of the present disclosure.

FIGS. 14A-D illustrate over-lapping tests for a water-based stain including various amounts of polymeric particle additives, in accordance with various aspects of the present disclosure.

FIGS. 15A-D illustrate over-lapping tests for water-based wood stain including a polymeric particle additive and tested on various types of wood, in accordance with various aspects of the present disclosure.

FIG. 16A illustrates a photograph of an emulsion including a particle additive having a particle size of 80 nm, in accordance with various aspects of the present disclosure

FIG. 16B illustrates a photograph of an overlapping test for a waterborne wood stain that includes particle additive having a particle size of 80 nm, in accordance with various aspects of the present disclosure

FIG. 16C illustrates a photograph of an emulsion including a particle additive having a particle size of 80 nm after being subjected to a heat age test, in accordance with various aspects of the present disclosure.

FIG. 17A illustrates a photograph of an overlapping test for a waterborne wood stain that includes particle additive having a particle size of 35 nm, in accordance with various aspects of the present disclosure.

FIG. 17B illustrates a photograph of an overlapping test for a waterborne wood stain that includes particle additive having a particle size of 45 nm, in accordance with various aspects of the present disclosure.

FIG. 17C illustrates a photograph of an overlapping test for a waterborne wood stain that includes particle additive having a particle size of 55 nm, in accordance with various aspects of the present disclosure.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)O—₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O(oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some aspects, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some aspects, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain aspects there is no hydrocarbyl group.

As used herein, the term “polymer” refers to a molecule having at least one repeating unit and can include copolymers.

The polymers described herein can terminate in any suitable way. In some aspects, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

### Additive for a Water-Based Wood Stain.

Various aspects of the present invention provide an additive for a water-based wood stain. The additive includes a polymeric particle that includes a polymer. The polymer includes a repeating unit formed from (i.e., the polymer is formed from a reaction mixture including) a compound having the formula X-L¹-A. The variable X can be a substituted or unsubstituted (C₂-C₈)alkenyl containing one or more carbon-carbon double bonds. The variable L¹ can be a bond, —C(O)—O—, —O—C(O)—, or a substituted or unsubstituted (C₁-C₁₀)alkylene interrupted by 0, 1, 2, or 3 heteroatoms chosen from O and NR¹ wherein R¹ is —H or (C₁-C₅)alkyl. The variable A can be —H, substituted or unsubstituted (C₁-C₂₀)hydrocarbyl, or substituted or unsubstituted phenyl. The polymeric particle can have a particle size in solution (e.g., water) of 10 nm to 2000 nm.

The polymeric particle can be the polymer. The polymeric particle can have any suitable particle size in solution, such as 10 nm to 2,000 nm, 10 nm to 1,500 nm, 10 nm to 200 nm, 10 nm to 150 nm, 10 nm to 100 nm, 30 nm to 80 nm, or equal to or less than 2,000 nm and greater than or equal to 10 nm and less than, equal to, or greater than 20 nm, 30, 40, 50, 60, 70, 80, 90, 100, 110, 120, 130, 140, 150, 160, 170, 180, 190, 200, 225, 250, 275, 300, 400, 500, 750, 1,000, 1,250, 1,500, or 1,750 nm. As used herein, “particle size” of the polymeric particles refers to the intensity weighted mean hydrodynamic size of the polymeric particles as measured by dynamic light scattering (DLS), at 25° C., using a dispersion of the polymeric particles in water having a concentration of 0.01 g/mL.

The additive can be a solution and/or suspension of the polymeric particle in one or more solvents. The polymeric particle (i.e., a plurality of the polymeric particles) can form any suitable proportion of the additive, such as 1 wt % to 60 wt %, or 10 wt % to 50 wt %, or less than or equal to 60 wt % and greater than or equal to 1 wt %, 2, 4, 6, 8, 10, 12, 14, 16, 18, 20, 22, 24, 26, 28, 30, 32, 34, 36, 38, 40, 42, 44, 46, 48, 50, or 55 wt %. The one or more solvents can be any suitable one or more solvents, such as water and/or one or more water-miscible solvents, such as an alcohol, a diol, 1,4-dioxane, ethanol, ethylamine, ethylene glycol, formic acid, furfuryl alcohol, glycerol, methanol, methyl diethanolamine, methyl isocyanide, N-methyl-2-pyrrolidone, 1-propanol, 1,3-propanediol, 1,5-pentanediol, 2-propanol, propanoic acid, propylene glycol, pyridine, tetrahydrofuran, triethylene glycol, or a combination thereof.

The variable X can be a substituted or unsubstituted (C₂-C₈)alkenyl containing one or more carbon-carbon double bonds. The variable X can be unsubstituted. The variable X can be a (C₂-C₄)alkenyl containing a single carbon-carbon double bond. The variable X can be a vinyl group.

The variable L¹ can be a bond, —C(O)—O—, —O—C(O)—, or a substituted or unsubstituted (C₁-C₁₀)alkylene interrupted by 0, 1, 2, or 3 heteroatoms chosen from O and NR¹ wherein R¹ is —H or (C₁-C₅)alkyl. The variable L¹ can be an unsubstituted (C₁-C₁₀)alkylene. The variable L¹ can be a bond.

The variable A can be —H, substituted or unsubstituted (C₁-C₂₀)hydrocarbyl, or substituted or unsubstituted phenyl. The variable A can be substituted or unsubstituted phenyl. The variable A can be an unsubstituted phenyl ring.

The compound having the formula X-L¹-A can be a-methylstyrene, trans-O-methylstyrene, 2-methyl-1-phenyl-1-propene, allylbenzene, 2-methylstyrene, methylstyrene, 4-methylstyrene, or styrene. The compound having the formula X-L¹-A can be styrene.

The repeating unit formed from the compound having the formula X-L¹-A can be any suitable proportion of the polymer, such as 1 wt % to 100 wt % of the polymer, 5 wt % to 50 wt % of the polymer, or 100 wt % or less and greater than or equal to 1 wt %, 2, 4, 6, 8, 10, 12, 14, 16, 18, 20, 22, 24, 26, 28, 30, 32, 34, 36, 38, 40, 42, 44, 46, 48, 50, 55, 60, 65, 70, 75, 80, 85, 90, or 95 wt %.

In some aspects, the repeating unit formed from the compound having the formula X-L¹-A is the only repeating unit in the polymer. In other aspects, the polymer further includes a repeating unit formed from a compound having the formula Y-L²-C(O)—O—B or Y-L²-O—C(O)—B. The variable Y can be a substituted or unsubstituted (C₂-C₈)alkenyl containing one or more carbon-carbon double bonds. The variable L² can be a bond or a substituted or unsubstituted (C₁-C₁₀)alkylene interrupted by 0, 1, 2, or 3 heteroatoms chosen from O and NR¹ wherein R¹ is —H or (C₁-C₅)alkyl. The variable B can be —H or a substituted or unsubstituted (C₁-C₂₀)hydrocarbyl. In some aspects, the repeating units formed from X-L¹-A, Y-L²-C(O)—O—B, and/or Y-L²-O—C(O)—B are the only repeating units in the polymer; in other aspects, the polymer includes one or more additional repeating units.

The variable Y can be a substituted or unsubstituted (C₂-C₈)alkenyl containing one or more carbon-carbon double bonds. The variable Y can be unsubstituted. The variable Y can be a (C₂-C₄)alkenyl containing a single carbon-carbon double bond. The variable Y can be a vinyl group.

The variable L² can be a bond or a substituted or unsubstituted (C₁-C₁₀)alkylene interrupted by 0, 1, 2, or 3 heteroatoms chosen from O and NR¹ wherein R¹ is —H or (C₁-C₅)alkyl. The variable L² can be an unsubstituted (C₁-C₁₀)alkylene. The variable L² can be a bond.

The variable B can be —H or a substituted or unsubstituted (C₁-C₂₀)hydrocarbyl. The variable B can be —H. The variable B can be an unsubstituted (C₁-C₂₀)alkyl. The variable B can be (C₁-C₅)alkyl. The variable B can be methyl, ethyl, propyl, iso-propyl, butyl, or tert-butyl.

The compound having the formula Y-L²-C(O)—O—B can be an alpha, beta-unsaturated ester. The compound having the formula Y-L²-C(O)—O—B can be tert-butyl methacrylate, sec-butyl methacrylate, benzyl methacrylate, 4-acetoxystyrene, phenyl methacrylate, ethylene glycol phenyl ether methacrylate, butyl methacrylate, 2-ethylhexyl acrylate, acrylic acid, methacrylic acid, acetoacetoxyethyl methacrylate, methacrylic acid, methyl methacrylate, methyl acrylate, ethyl acrylate, butyl acrylate, or tert-butyl acrylate. The compound having the formula Y-L²-C(O)—O—B can be methyl methacrylate, methacrylate, butylacrylate, or tert-butylacrylate.

The compound having the formula or Y-L²-O—C(O)—B can be, for example, vinyl acetate.

The repeating unit formed from the compound having the formula Y-L²-C(O)—O—B or Y-L²-O—C(O)—B can be any suitable proportion of the polymer, such as is 1 wt % to 99 wt % of the polymer, or 50 wt % to 95 wt %, or less than or equal to 99 wt % and greater than or equal to 1 wt %, 2, 4, 6, 8, 10, 12, 14, 16, 18, 20, 25, 30, 35, 40, 45, 50, 55, 60, 65, 70, 75, 80, 85, 90, or 95 wt %. The repeating unit formed from the compound having the formula X-L¹-A and the repeating unit formed from the compound having the formula Y-L²-C(O)—O—B or Y-L²-O—C(O)—B can have a weight ratio of 0.01:1 to 99:1, or 0.05:1 to 1:1, or less than or equal to 99:1 and greater than or equal to 0.01:1, 0.02:1, 0.03:1, 0.04:1, 0.05:1, 0.06:1, 0.08:1, 0.1:1, 0.2:1, 0.3:1, 0.4:1, 0.5:1, 0.6:1, 0.7:1, 0.8:1, 0.9:1, 1:1, 2:1, 4:1, 6:1, 8:1, 10:1, 15:1, 20:1, 25:1, 30:1, 40:1, 50:1, 60:1, 70:1, 80:1, or 90:1.

In various aspects, the polymer is saponified after polymerization, such that the the —C(O)—O—B structure in the saponified polymer is —C(O)—O—H or wherein the —O—C(O)—B structure in the saponified polymer is —C—O—H.

In various aspects, the polymer can be poly(styrene-co-(methyl methacrylate)), poly(styrene-co-methacrylate), poly(styrene-co-(butyl acrylate)), poly(styrene-co-(tert-butyl acrylate)), or poly(styrene-co-(vinyl alcohol)).

The repeating unit formed from a compound having the formula X-L¹-A and the repeating unit formed from a compound having the formula Y-L²-C(O)—O—B or Y-L²-O—C(O)—B forms a hydrophilic lobe of the polymer, wherein the polymer further includes a crosslinked polymeric hydrophobic lobe that is connected to the polymer in place of the B in the —C(O)—O—B structure or in place of the —C(O)—B in the —O—C(O)—B structure. The polymeric particle including the hydrophilic lobe and the hydrophobic lobe is an amphiphilic Janus particle. In various aspects, the amphiphilic Janus particles can be self-stratifying, such that a coating including the particles will orient their hydrophobic lobe toward air. The Janus particle can include a hydrophobic surface area of 30% to 90% or 40% to 80%. Self-stratification of the Janus particles can be determined, for example, by measuring the water contact angle of the coating surfaces.

The crosslinked polymeric hydrophobic lobe can include one or more repeating units each formed from one or more acrylate esters. The crosslinked polymeric hydrophobic lobe can include a repeating unit formed from (C₅-C₃₀)alkyl acrylate and/or (C₅-C₃₀)alkyl methacrylate. The crosslinked polymeric hydrophobic lobe can include a repeating unit formed from (C₁₀-C₂₀)alkyl acrylate and/or (C₁₀-C₂₀)alkyl methacrylate. The crosslinked polymeric hydrophobic lobe can include a repeating unit formed from ethylene glycol dimethacrylate. The crosslinked polymeric hydrophobic lobe can include a repeating unit formed from divinylpyrrolidone.

In aspects of the polymer including a hydrophilic lobe and a hydrophobic lobe, the hydrophobic lobe can be any suitable proportion of the polymer, such as 10 wt % to 90 wt % of the polymer, 30 wt % to 70 wt % of the polymer, or equal to or less than 90 wt % and equal to or greater than 10 wt %, 15, 20, 25, 30, 35, 40, 45, 50, 55, 60, 65, 70, 75, 80, or 85 wt %. The hydrophilic lobe cab be any suitable proportion of the polymer, such as 10 wt % to 90 wt % of the polymer, 30 wt % to 70 wt % of the polymer, or equal to or less than 90 wt % and equal to or greater than 10 wt %, 15, 20, 25, 30, 35, 40, 45, 50, 55, 60, 65, 70, 75, 80, or 85 wt %.

The additive can optionally include a surfactant. In various aspects, the additive is free of surfactants. Aspects of the additive including a surfactant can include any suitable surfactant, such as an ionic surfactant (e.g., anionic, cationic, zwitterionic), or a non-ionic surfactant. Examples of a non-ionic surfactant include an ethoxylate (e.g., fatty alcohol ethoxylate, alkylphenol ethoxylate, fatty acid ethoxylate, ethoxylated fatty esters or oils, ethoxylated amines and/or fatty acid amides, terminally blocked ethoxylates), fatty acid esters of polyhydroxy compounds (e.g., fatty acid esters of glycerol, fatty acid esters of sucrose, fatty acid esters of sorbitol such as Tween), alkyl polyglucosides, or a combination thereof. The surfactant can form any suitable proportion of the additive, such as 0.01 wt % to 50 wt %, or less than or equal to 50 wt % and greater than or equal to 0.01 wt %, 0.05, 0.1, 0.5, 1, 2, 4, 6, 8, 10, 12, 14, 16, 18, 20, 25, 30, 35, 40, or 45 wt %. The surfactant can form any suitable proportion of a water-based stain that includes the additive, such as 0.01 wt % to 20 wt %, or 0.1 wt % to 5 wt %, or less than or equal to 20 wt % and greater than or equal to 0.01 wt %, 0.05, 0.1, 0.5, 1, 2, 3, 4, 5, 6, 7, 8, 9, 10, 11, 12, 13, 14, 15, 16, 17, 18, or 19 wt %.

Various aspects of the present invention provide a cured and/or dried product of the additive. In various aspects, the cured and/or dried product of the additive can be a cured and/or dried product of a water-based stain including the additive. In various aspects, upon curing/drying, the water-based stain including the additive can have a substantially identical composition to the water-based stain prior to curing/drying other than the removal of solvents therefrom. In various aspects, upon curing/drying, other than the removal of solvents therefrom, the water-based stain including the additive can have a different composition as compared to the water-based stain prior to curing/drying, such as resulting from chemical reactions between the polymeric particles or between a polymeric particle and one or more other materials in the water-based stain.

Various aspects of the present invention provide a method of making the additive. The method can include heating a reaction mixture, to form the additive. The reaction mixture can include a free-radical initiator as well as at least one monomer that includes carbon-carbon unsaturated bond or a vinyl group. Heating the reaction mixture can cause the reactants therein to undergo emulsion polymerization to generate the additive.

The free-radical initiator can be any suitable free-radical initiator that can initiate emulsion polymerization of the one or more monomers. For example, the free-radical initiator can include potassium persulfate, 2,2′-azobis(isobutyronitrile) (AIBN), or a combination thereof.

The reaction mixture can further include a surfactant. The surfactant can be any suitable surfactant that can sustain conditions for emulsion polymerization to form the additive. For example, the surfactant can include sodium dodecyl sulfate.

The reaction mixture can further include a solvent. The solvent can include an aqueous solvent and/or an organic solvent. The solvent can include an alcohol, such as ethanol.

The at least one monomer can include any monomer described herein. The at least one monomer can be a compound having the formula X-L¹-A, wherein X is a substituted or unsubstituted (C₂-C₈)alkenyl containing one or more carbon-carbon double bonds, L¹ is a bond, —C(O)—O—, —O—C(O)—, or a substituted or unsubstituted (C₁-C₁₀)alkylene interrupted by 0, 1, 2, or 3 heteroatoms chosen from O and NR¹ wherein R¹ is —H or (C₁-C₅)alkyl, and A is —H, substituted or unsubstituted (C₁-C₂₀)hydrocarbyl, or substituted or unsubstituted phenyl. The at least one monomer can be a compound having the formula Y-L²-C(O)—O—B or Y-L²-O—C(O)—B, wherein Y is a substituted or unsubstituted (C₂-C₈)alkenyl containing one or more carbon-carbon double bonds, L² is a bond or a substituted or unsubstituted (C₁-C₁₀)alkylene interrupted by 0, 1, 2, or 3 heteroatoms chosen from O and NR¹ wherein R¹ is —H or (C₁-C₅)alkyl, and B is —H or a substituted or unsubstituted (C₁-C₂₀)hydrocarbyl. For example, the monomer can include a-methylstyrene, trans-p-methylstyrene, 2-methyl-1-phenyl-1-propene, allylbenzene, 2-methylstyrene, methylstyrene, 4-methylstyrene, styrene, tert-butyl acrylate, tert-butyl methacrylate, sec-butyl methacrylate, benzyl methacrylate, 4-acetoxystyrene, phenyl methacrylate, ethylene glycol phenyl ether methacrylate, butyl methacrylate, 2-ethylhexyl acrylate, acrylic acid, methacrylic acid, acetoacetoxyethyl methacrylate, methacrylic acid, methyl methacrylate, methyl acrylate, ethyl acrylate, butyl acrylate, tert-butyl acrylate, or a combination thereof.

The method can further include separating the additive from the reaction mixture. The separation include any suitable separation method, such as filtration, decantation, centrifugation, or a combination thereof.

The method can further include deoxygenating the reaction mixture. The deoxygenation can be performed before and/or during the heating of the reaction mixture. The deoxygenating can include bubbling an inert gas through the reaction mixture, such as argon and/or nitrogen.

In various aspects, the reaction mixture that is heated contains the entire quantity of the free-radical initiator and the entire quantity of the at least one monomer used to form the additive. In other aspects, the reaction mixture includes a portion of the free-radical initiator at the onset of the heating, and the method further includes adding an additional portion (e.g., the remainder) of the free-radical initiator to the reaction mixture during the heating, such as via titration into the reaction mixture. The reaction mixture can include a portion of the at least one monomer at the onset of the heating, and the method can further include adding an additional portion (e.g., the remainder) of the at least one monomer to the reaction mixture during the heating, such as via titration into the reaction mixture. In various aspects, the reaction mixture includes a portion of the free-radical initiator and a portion of the at least one monomer at the onset of the heating, and the method can further include adding an additional portion of both the free-radical initiator and the at least one monomer to the reaction mixture during the heating, such as via titration into the reaction mixture. In various aspects, titration of one or both of the additional portions of the free-radical initiator and the at least one monomer into the reaction mixture during the heating can cause the formation of additive having a small particle size in solution, such as a particle size of 10 nm to 2,000 nm, 10 nm to 100 nm, 30 nm to 80 nm, or equal to or less than 2,000 nm and greater than or equal to 10 nm and less than, equal to, or greater than 20 nm, 30, 40, 50, 60, 70, 80, 90, 100, 110, 120, 130, 140, 150, 160, 170, 180, 190, 200, 225, 250, 275, 300, 400, 500, 750, 1,000, 1,250, 1,500, or 1,750 nm.

Various aspects of the present invention provide a method of using the additive of the present invention. The method can include combining the additive with a water-based stain, to form a water-based stain that includes the additive. The method can further include staining wood with the water-based stain that includes the additive.

### Water-Based Wood Stain.

Various aspects of the present invention provide a water-based wood stain that includes the additive of the present invention that includes a polymeric particle that includes a polymer that includes a repeating unit formed from (i.e., the polymer is formed from a reaction mixture including) a compound having the formula X-L¹-A. The polymeric particles can have any suitable concentration in the water-based wood stain, such as 0.1 wt % to 20 wt %, 1 wt % to 10 wt %, 2 wt % to 5 wt %, or equal to or less than 20 wt % and greater than or equal to 0.1 wt %, 0.5, 1, 2, 3, 4, 5, 6, 7, 8, 9, 10, 11, 12, 13, 14, 15, 16, 17, 18, or 19 wt %. Any suitable proportion of the water-based wood stain can be water, such as at least 50 wt %, or such as 20-95 wt %, or less than or equal to 95 wt % and greater than or equal to 20 wt %, 25, 30, 35, 40, 45, 50, 55, 60, 65, 70, 75, 80, 85, or 90 wt %. The additive of the present invention can conveniently be added to a base water-based stain (e.g., a conventional water-based stain) to form the water-based wood stain including the additive, or the additive can be added at the time of stain manufacturing such that the water-based stain including the additive is directly available to a consumer.

The water-based wood stain that includes the additive can be a combination of the additive and any conventional water-based stain. For example, the water-based wood stain can include one or more water-based binders, such as an acrylic resin, epoxy resin, alkyd resin, polyester resin, polyurethane resin, waterborne lattices, waterborne electrophoretic deposition resins, waterborne hybrid resins, or a combination thereof. The one or more binders can be any suitable proportion of the water-based stain, such as 1 wt % to 30 wt %, or 1 wt % to 10 wt %, or less than or equal to 30 wt % and greater than or equal to 1 wt %, 2, 3, 4, 5, 6, 8, 10, 12, 14, 16, 18, 20, 22, 24, 26, or 28 wt %.

Various aspects of the present invention provide a method of making the water-based stain of the present invention. The method can include combining the additive of the present invention and a water-based stain to form the water-based wood stain of the present invention.

Various aspects of the present invention provide a method of using the water-based wood stain of the present invention. The method can include applying the water-based stain to wood. The wood can be any suitable wood, such as oak, maple, pine, birch, cherry, cedar, walnut, beech, mahogany, mango, acacia, Mindi, ash, teak, or a combination thereof. The wood can include oak or maple. The method can further include at least partially drying the water-based stain on the wood. The method can further include applying a subsequent coating of the water-based stain; for example, the method can further include applying the water-based stain on top of the at least partially dried water-based stain on the wood.

Various aspects of the present invention provide an article including wood, wherein the wood includes the water-based stain of the present invention that includes the additive including polymeric particles, or a dried and/or cured product of the water-based stain. The article can include multiple coats of the water-based stain, such that a subsequent coat is on top of a prior coat.

### EXAMPLES

Various aspects of the present invention can be better understood by reference to the following Examples which are offered by way of illustration. The present invention is not limited to the Examples given herein. All percentages in the Examples refer to weight percentage unless otherwise indicated. As used in the Examples, “particle size” of the polymeric particles refers to the diameter of the particles as determined by dynamic light scattering using a Zetasizer Nano ZS (Malvern Panalytical Ltd.). Prior to conducting the measurement, particle additive dispersions were diluted to ˜0.01 g/mL and then introduced into a thermostated scattering cell at 25° C. Deionized water was used as the solvent. The measured particle size was the intensity weighted mean hydrodynamic size of the ensemble collection of the particles measured by dynamic light scattering (DLS).

Materials. Styrene (St, 99%), ethanol (EtOH, 200 Proof, 100%), polyvinylpyrrolidone (PVP, Mₙ=40 000 g mol⁻¹), divinylbenzene (DVB, 99%), potassium persulfate (KPS), sodium dodecyl sulfate (SDS), poly(vinyl alcohol) (PVA, Mw=13 000-23 000 g mol⁻¹, 87-89% hydrolyzed), ethylene glycol dimethacrylate (EGDMA, 98%), 1-hydroxycyclohexyl phenylketone (Irgacure 184, 99%), Pluronic F-127 (Poloxamer 407), 2,2′-azobis(isobutyronitrile) (AIBN, 98%), phosphoric acid 2-hydroxyethyl methacrylate ester and vinyl acetate (VAc, 99%) were purchased from Sigma-Aldrich (USA). Tetradecyl acrylate (TA) was purchased from TCI chemicals (Japan). Peel Stop® Clear Binding Primer was purchased from Zinsser. Resin AC 2736, AC3600, AC3640, AC3699, Old Masters interior water-based wood stain, DJ03-48893 Triclad Select Wiping Stain, Lattice NTC 90, Surfynol AD-01, and carbon black were provided from Diamond Vogel. Deionized triple distilled water was used in all experiments. All chemicals were of reagent grade and used without further purification.

### Example 1. Synthesis of Polymeric Particles

Synthesis of polystyrene particles. Polystyrene particles were prepared by emulsion polymerization. Typically, in a 100 mL round-bottom flask, 0.0125-0.08 g SDS was dissolved in DI water with a total weight of 50 g under mechanical stirring, 4.67 ml styrene, 0.832 ml DVB and 0.15 g KPS was then added into the flask. The solution was deoxygenated by bubbling argon for 15 min. The flask was then placed in an oil bath at 65±1C and mechanical stirring was performed at 500 rpm. After polymerization for 24 h, the milky emulsion of polystyrene particles was cooled under room temperature then washed and separated by centrifugation at 14000 rpm in the ethanol-water mixture for three times.

Synthesis of poly(styrene-co-(acrylate ester)) particles. Poly(styrene-co(acrylate ester)) particles with different glass transition temperatures than the polystyrene particles were prepared by emulsion polymerization. Typically, in a 100 mL round-bottom flask, 0.0125 g SDS was dissolved in DI water with a total weight of 50 g under mechanical stirring, 4.67 ml styrene, 2.5 ml acrylate (methyl methacrylate, butyl acrylate, tert-butyl acrylate), 0.832 ml DVB and 0.15 g KPS was then added into the flask. The solution was deoxygenated by bubbling argon for 15 min. The flask was then placed in an oil bath at 65±1° C. and 500 rpm of mechanical stirring rate was applied. After polymerization for 24 h, the milky emulsion of the poly(styrene-co(acrylate ester)) particles was cooled under room temperature.

Synthesis of poly(styrene-co-(tert-butyl acrylate)) particles. Poly(styrene-co-(tert-butyl acrylate)) particles were prepared by emulsion polymerization. Typically, in a 100 mL round-bottom flask, 0.01-0.8 g SDS was dissolved in DI water with a total weight of 40 g under mechanical stirring, 1 ml styrene, 9 ml tert-butyl acrylate and 0.3 g KPS was then added into the flask. The flask was then placed in an oil bath at 70±1° C. and 400 rpm of mechanical stirring rate was applied. After polymerization for 24 h, the milky emulsion of poly(styrene-co-(tert-butyl acrylate)) additives was cooled under room temperature.

Synthesis of poly(styrene-co(vinyl alcohol)) particles. Poly(styrene-co-(vinyl acetate) particles (seed particles) were synthesized using dispersion polymerization. Styrene (4 mL), vinyl acetate (1 mL), PVP (2.0 g, a stabilizer), and AIBN (0.05 g, an initiator) were dissolved in a mixture of EtOH (25 mL, 200 proofs) and deionized water (25 mL) in a 100 mL round-bottom flask. The reaction mixture was purged with argon for 15 mins to remove oxygen. Then, the polymerization was carried out at 70° C. in an oil bath while stirring at 200 rpm for 36 h. After the polymerization, the particles were washed repeatedly via centrifugation with EtOH/water mixture (1/1, v/v). Then, the poly(styrene-co-(vinyl acetate)) seed particles were converted into poly(styrene-co-(vinyl alcohol)) particles using saponification, which was carried out under basic conditions (NaOH solution at pH=10) for 8 h at room temperature. Last, the poly(styrene-co-(vinyl alcohol)) particles were stored in the EtOH/water mixture (2/1, v/v) with PVA (2 wt %) and Pluronic F-127 (2 wt %).

Synthesis of amphiphilic Janus particles. The poly(styrene-co-(vinyl alcohol)) particles (seed particles) were swollen with a mixture of TA (1.2 mL, a hydrophobic monomer), EGDMA (0.3 mL, a crosslinker), and Irgacure 184 (0.06 g) in the presence of PVA (2 wt %) and Pluronic F-127 (2 wt %) in an EtOH/water solution (1.5 mL) for 8 h at room temperature. In this step, the hydrophobic monomer swelling ratio against the poly(styrene-co-(vinyl alcohol)) seed particles (0.05 g) need to be carefully adjusted, by feeding the total monomer volume of TA and EGDMA at 0.8 mL (TA/EGDMA=4/1, v/v). After that, the monomers in the swollen particles were photopolymerized by UV irradiation for 5 min while tumbling at room temperature, which induced a phase separation between the poly(styrene-co-(vinyl alcohol)) seed phase and the secondary polymerized poly(tetradecyl acrylate) (PTA) phase. The poly(styrene-co-(vinyl alcohol))/PTA Janus particles were then washed repeatedly with a mixture of EtOH/water (1/1, v/v) to remove the remaining monomers and organic additives.

### Example 2. Stain Formulation and Testing of Polymeric Particles

In a typical experiment, coating formulations were prepared by mixing 1-5 wt % additive and 95-99 wt % water-based wood stain (Old Masters interior water-based wood stain: natural tint based 76104).

Wood stain test. Wood substrate (32 cm×15 cm) was prepared by sanding with sandpaper. It was divided into five regions (5 cm×15 cm) with masking tape (3M ScotchBlue 0.7 inches width). After thorough mixing, formulated waterborne wood stain was coated on top of the wood substrate in certain dimension (5 cm×4 cm) and wiped with absorbing wipes. It was dried under the room temperature for 30 mins, and another layer of coating was applied on the wood substrate (5 cm×8 cm) with over lapping initial layer (5 cm×4 cm). It was dried under the room temperature for 72 hours, and another layer of coating was applied on the wood substrate (5 cm×12 cm) with overlapping second layer (5 cm×8 cm).

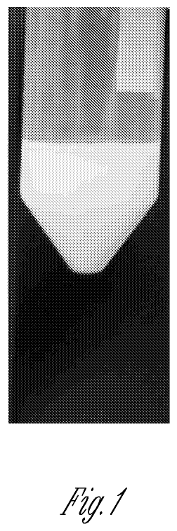

FIG. 1 illustrates a photograph of an aqueous suspension of polystyrene particles having a particle size of 400 nm.

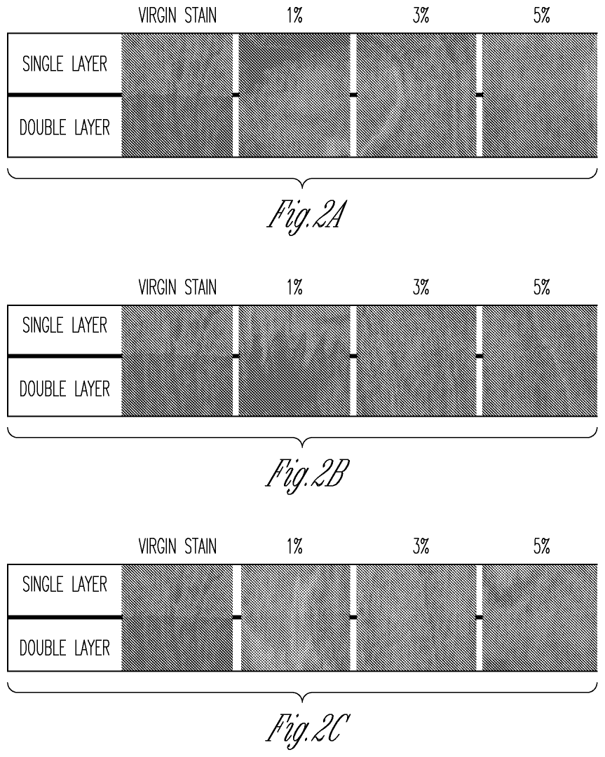

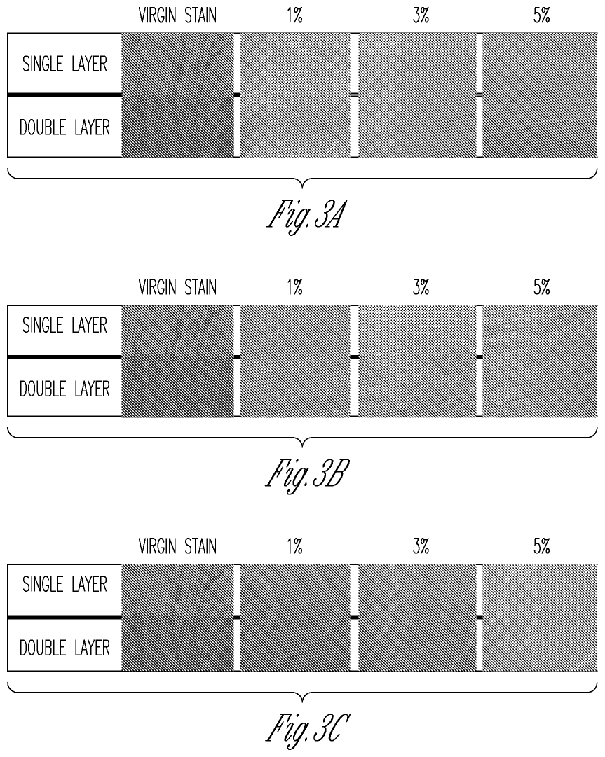

To test the lapping elimination capability of Janus particles as coating additives, a commercial water-based wood stain (Old Master, Interior water-based wood stain) was used as stain matrix. FIGS. 2A-C illustrate the results of the test, with FIG. 2A illustrating an over-lapping test for waterborne wood stain post-added with different amount of 200 nm Janus particle additives; FIG. 2B illustrating an over-lapping test for waterborne wood stain post-added with different amount of 400 nm Janus particle additives; FIG. 2C illustrating an over-lapping test for water-based wood stain post-added with different amount of 800 nm Janus particle additives; the single layer was applied at time “0”, double layer was applied at time “30 mins.” The original wood stain showed significant over-lapping after 30 mins interval application. After the amphiphilic Janus additives were post-added as an additive, lapping marks got reduced with a small amount of (1 wt %) additives dosage. After post-added amphiphilic Janus particles with 5 wt %, no lapping marks were observed. This clearly indicates that the Janus particle additive has the capability to reduce and eliminate wood stain lapping marks with high efficiency.

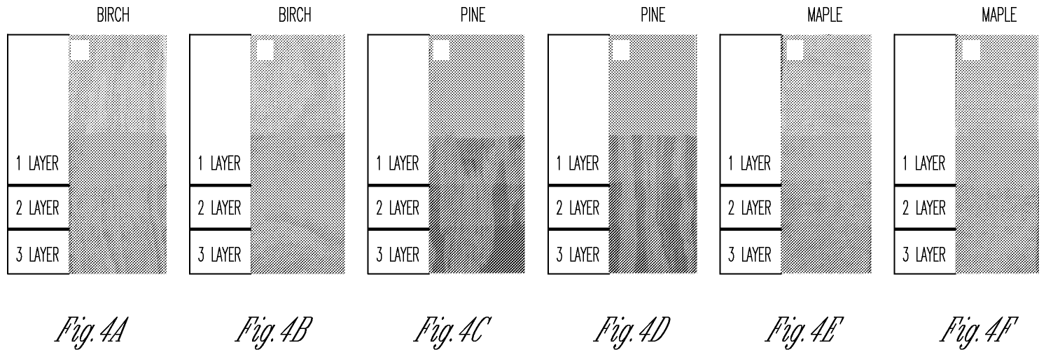

To test the lapping elimination capability of polystyrene particles as coating additives, a commercial water-based wood stain (Old Master, Interior water-based wood stain) was used as stain matrix. The original wood stain showed significant over-lapping after 30 mins interval application. After the polystyrene particles were added as an additive, lapping marks got significantly reduced with a small amount (1 wt % by solids) additives dosage. After adding polystyrene particles with 5 wt % by solids, no lapping marks were observed. FIGS. 3A-C illustrate the results of the test, with FIG. 3A illustrating an over-lapping test for waterborne wood stain post-added with different amount of 200 nm Polystyrene additive; FIG. 3B illustrating an over-lapping test for waterborne wood stain post-added with different amount of 400 nm Polystyrene particle additive; and with FIG. 3C illustrating an over-lapping test for water-based wood stain post-added with different amount of 1500 nm Polystyrene particle additive; the single layer was applied at time “0”, and the double layer was applied at time “30 mins.” Polystyrene particles with different sizes demonstrate same capability. This clearly indicates that the polystyrene particle additive has the capability to reduce and eliminate wood stain lapping marks with high efficiency.

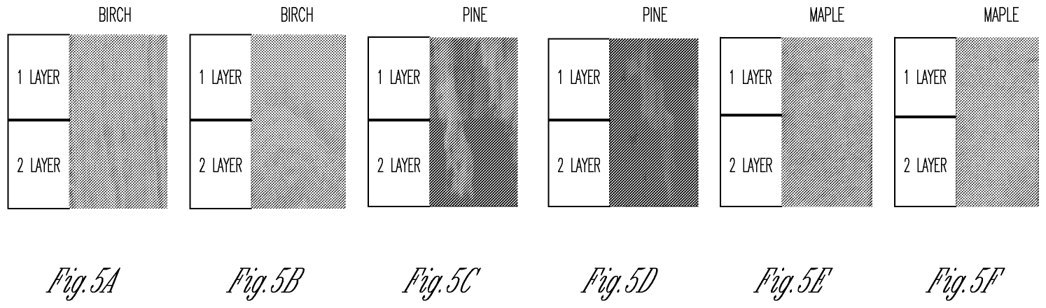

As shown in FIG. 4, to test the lapping elimination capability of polystyrene particle additive on different type of wood substrate (birch, pine and maple), a commercial water-based wood stain (Old Master, Interior water-based wood stain) was used as stain matrix. FIG. 4 illustrates overlapping tests for water-based wood stains post-added with 200 nm polystyrene particles: test 4A, original wood stain on birch wood; test 4B, stain post-added with polystyrene particle additive on birch wood; test 4C, original wood stain on pine wood; test 4D, stain post-added with polystyrene particles on pine wood; test 4E, original wood stain on maple wood; test 4F, stain post-added with Polystyrene particles on maple wood; first layer was applied at time “0”, second layer was applied at time “30 mins”, third layer was applied at time “72 hours”. In FIG. 4 at test A, C, and E, the original wood stain showed significant over-lapping after 30 mins and 72 hours interval application. After the 200 nm polystyrene particles were post-added as an additive with 3% by solids, no lapping marks were observed (FIG. 4 at test B, D, and F). This clearly indicates that the polystyrene particle additive has the capability to reduce and eliminate wood stain lapping marks on different type of wood substrate.

As shown in FIG. 5, to test the lapping elimination capability of polystyrene particles on different type of wood substrate (birch, pine and maple), a commercial water-based wood stain (Old Master, Interior water-based wood stain) was used as stain matrix. FIG. 5 illustrates over-lapping tests for various water-based stains including 400 nm polystyrene particles on various wood surfaces: A) original wood stain on birch wood; B) stain post-added with Polystyrene particles on birch wood; C) original wood stain on pine wood; D) stain post-added with Polystyrene particles on pine wood; E) original wood stain on maple wood; F) stain post-added with Polystyrene particles on maple wood; first layer was applied at time “0”, second layer was applied at time “30 mins”.

In FIG. 5 tests A, C, and E, the original wood stain showed significant over-lapping after 30 mins interval application. After the 400 nm polystyrene particles were post-added as an additive with 3% by solids, no lapping marks were observed (FIG. 5 tests B, D, and F). This clearly indicates that the polystyrene particle additive has the capability to reduce and eliminate wood stain lapping marks on different type of wood substrate.

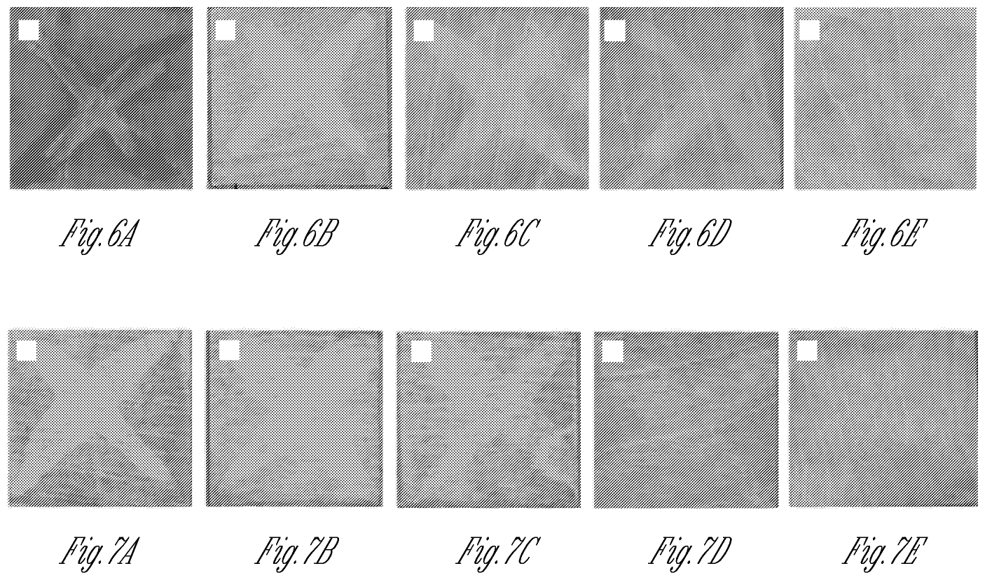

As shown in FIGS. 6A-E, to test the lapping elimination capability of polystyrene particles copolymerized with different type of acrylates, a commercial water-based wood stain (DJ03-48893 Triclad Select Wiping Stain) was used as stain matrix. Water-based wood stain was post-added with 2 wt % tween-20 and polystyrene additives copolymerized with different type of acrylates (10 wt % styrene, 90 wt % acrylate ester): FIG. 6A, original wood stain; FIG. 6B, styrene only (155 nm particle size); FIG. 6C, butyl acrylate (155 nm particle size); FIG. 6D, methyl methacrylate (189 nm particle size); and FIG. 6E, tert-butyl acrylate (102 nm particle size). In FIG. 6A, the original wood stain showed significant over-lapping after the “X” mark application. After the polystyrene particles copolymerized with different type of acrylates were post-added as an additive, by 5% solids, with 2 wt % tween-20, no lapping marks were observed with particles copolymerized with tert-butyl acrylate (FIG. 6E). This clearly indicates that the polystyrene particle additive copolymerized with tert-butyl acrylate has the capability to reduce and eliminate wood stain lapping marks with high efficiency.

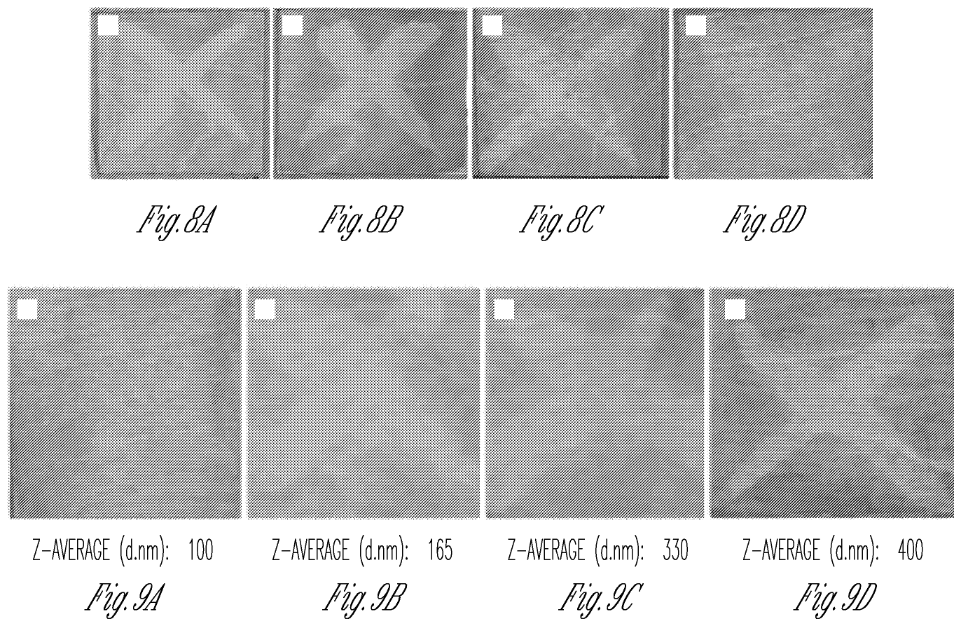

As shown in FIGS. 7A-E, to test the lapping elimination capability of polystyrene-co-poly(tert-butyl acrylate) particles with different monomer ratios, a commercial water-based wood stain (DJ03-48893 Triclad Select Wiping Stain) was used as stain matrix. Water-based stain was post-added with 2 wt % tween-20 and poly(styrene-co-tert-butyl acrylate) particles copolymerized with different tert-butyl acrylate ratios: FIG. 7A, original wood stain;

FIG. 7B, 25% tert-butyl acrylate (204 nm particle size); FIG. 7C, 50% tert-butyl acrylate (121 nm particle size); FIG. 7D, 75% tert-butyl acrylate (112 nm particle size); and FIG. 7E, 90% tert-butyl acrylate (102 nm particle size). In FIGS. 7A-E, lapping marks were reduced with particles having higher tert-butyl acrylate ratios. After post-adding polystyrene particles copolymerized with 75% to 90% tert-butyl acrylate, no lapping marks were observed (FIGS. 7D, 7E). This clearly indicates that the polystyrene-co-poly(tert-butyl acrylate) particle additive with higher tert-butyl acrylate amounts has the capability to reduce and eliminate wood stain lapping marks with high efficiency.

As shown in FIGS. 8A-D, to test the lapping elimination capability of poly(styrene-co-(tert-butyl acrylate)) particles with different surfactant dosage, a commercial water-based wood stain (DJ03-48893 Triclad Select Wiping Stain) was used as stain matrix. Water-based stain was post-added with 5 wt % poly (styrene-co-tert-butyl acrylate) additives (10 wt % styrene with 90 wt % acrylate ester) and tween-20 in different amounts (all polymeric particles had a particle size of 102 nm): FIG. 8A, original wood stain; FIG. 8B, post-added with poly (styrene-co-tert-butyl acrylate) only; FIG. 8C, post-added with poly (styrene-co-tert-butyl acrylate) with 1 wt % tween-20; and FIG. 8D, post-added with poly (styrene-co-tert-butyl acrylate) with 2 wt % tween-20. In FIGS. 8B-D, lapping marks got reduced with same amount of particles loading (5 wt %) and higher tween 20 surfactant dosage. After post-added 5 wt % poly(styrene-co-(tert-butyl acrylate)) particles with 2 wt % tween 20 surfactant, no lapping marks were observed (FIG. 8D). This clearly indicates that the polystyrene-co-poly(tert-butyl acrylate) particle additive mixed with higher tween 20 surfactant amount has the capability to reduce and eliminate wood stain lapping marks with high efficiency.

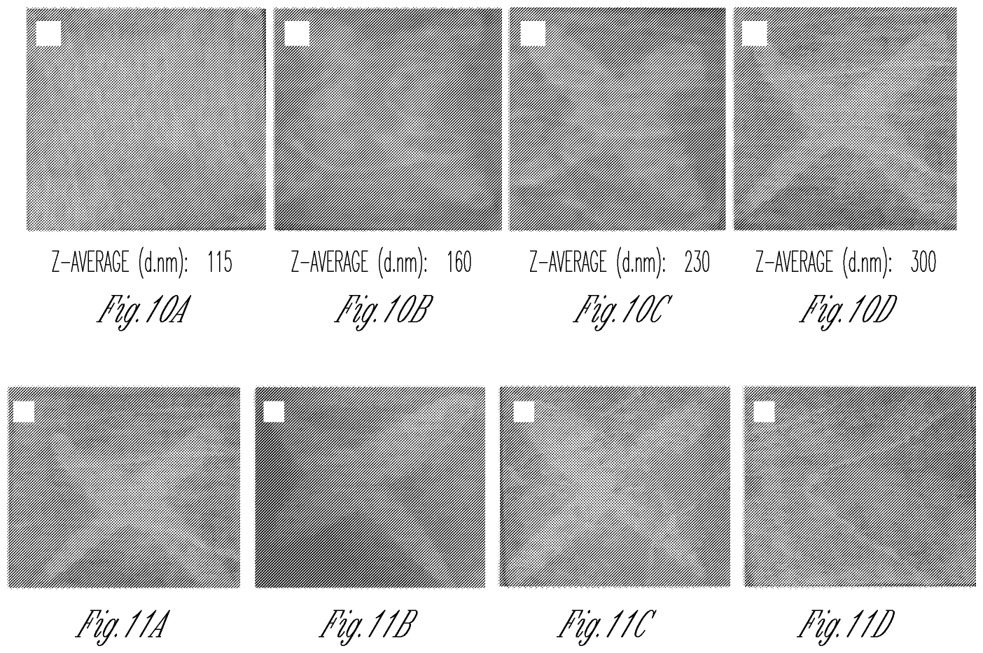

As shown in FIGS. 9A-D, to test the size effect on the lapping elimination capability of styrene copolymerized with 75% tert-Butyl acrylate, a commercial water-based wood stain (DJ03-48893 Triclad Select Wiping Stain) was used as stain matrix. FIGS. 9A-D illustrates overlapping tests for water-based wood stains post-added with 2 wt % tween-20 and poly(styrene-co-tert-butyl acrylate) copolymerized with 75% tert-butyl acrylate and having various particle sizes: FIG. 9A, 100 nm particles; FIG. 9B, 165 nm particles; FIG. 9C, 330 nm particles; and FIG. 9D, 400 nm particles. In FIG. 9A, the poly (styrene-co-tert-butyl acrylate) particles with 100 nm showed significant over-lapping elimination, after the “X” mark application. As the particles sizes increased with constant chemical composition, the lapping elimination capability was reduced (FIGS. 9B-D). This clearly indicates that the size of the poly(styrene-co-tert-butyl acrylate) particles has strong impact on the capability to reduce and eliminate wood stain lapping marks.

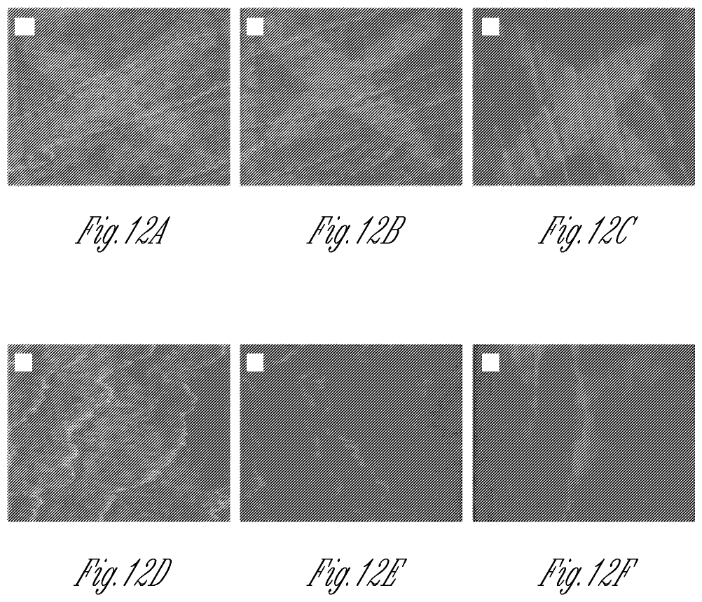

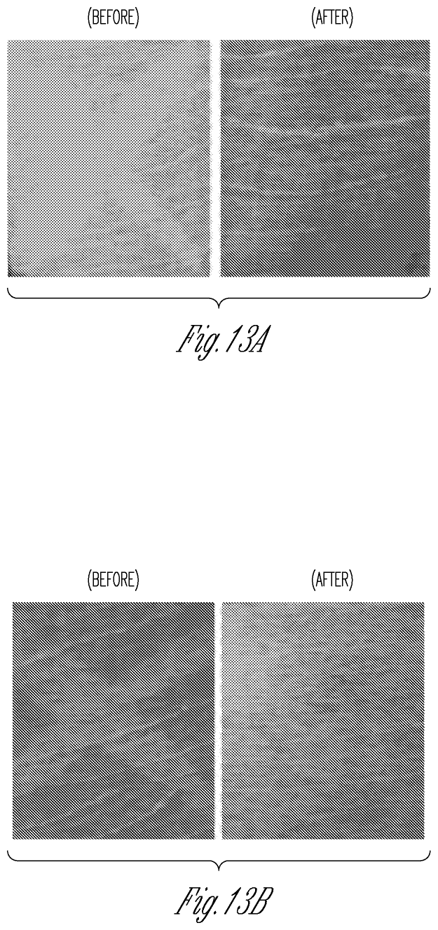

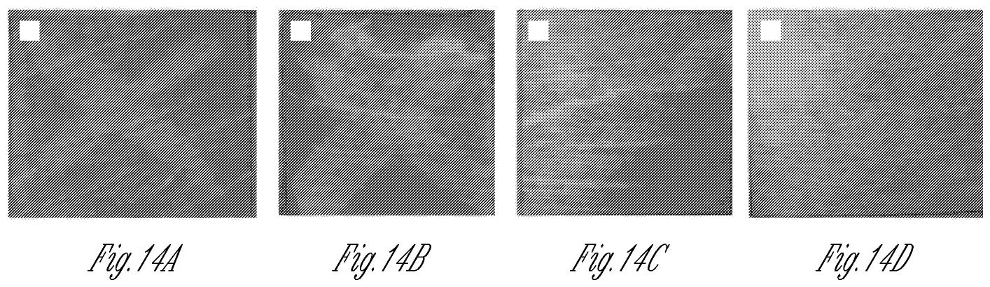

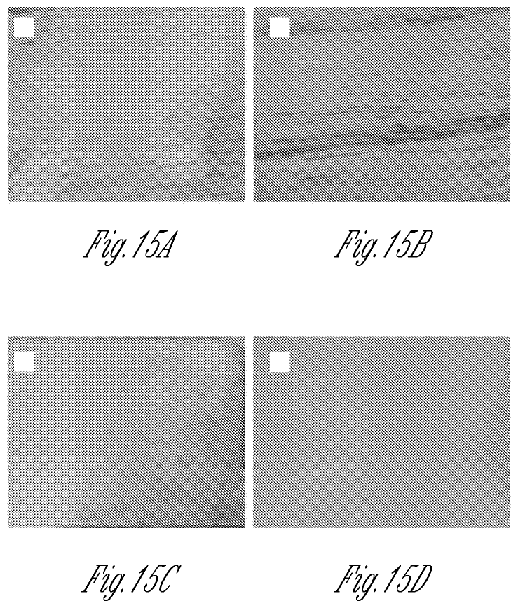

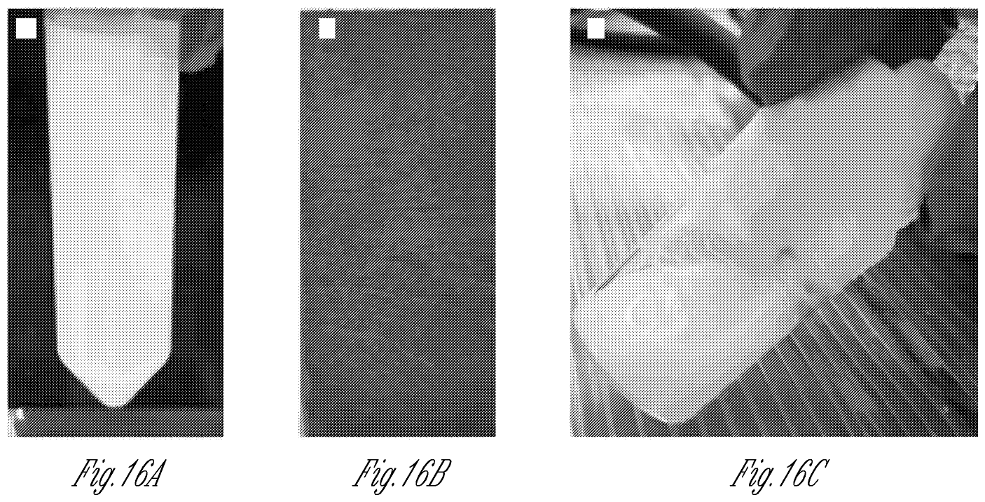

As shown in FIGS. 10A-D, to test the size effect on the lapping elimination capability of styrene copolymerized with 90% tert-butyl acrylate, a commercial water-based wood stain (DJ03-48893 Triclad Select Wiping Stain) was used as stain matrix. FIGS. 10A-D illustrate water-based stains post-added with 2 wt % tween-20 and poly (styrene-co-tert-Butyl acrylate) copolymerized with 90% tert-butyl acrylate and having various particle sizes: FIG. 10A, 115 nm particles; FIG. 10B, 160 nm particles; FIG. 10C, 230 nm particles; and FIG. 10D, 300 nm particles. In FIG. 10A, the poly (styrene-co-tert-butyl acrylate) particles with 115 nm showed significant over-lapping elimination, after the “X” mark application. As the particles sizes increased with constant chemical composition, the lapping elimination capability were reduced (FIGS. 10B-D). This clearly indicates that the size of the poly (styrene-co-tert-butyl acrylate) particles has strong impact on the capability to reduce and eliminate wood stain lapping marks.

As shown in FIGS. 11A-D, to test the lapping elimination capability of poly (styrene-co-tert-b acrylate) particles with different additives loading, a commercial water-based wood stain (DJ03-48893 Triclad Select Wiping Stain) was used as stain matrix. FIGS. 11A-D illustrate over-lapping tests for water-based stains post-added with 2 wt % tween-20 and different amount of poly (styrene-co-tert-butyl acrylate) particles (10 wt % styrene with 90 wt % acrylate ester, particle sizes 102 nm): FIG. 11A, original wood stain; FIG. 11B, added 1 wt % poly (styrene-co-tert-butyl acrylate); FIG. 11C, 2.5 wt % poly (styrene-co-tert-butyl acrylate); FIG. 11D, 5 wt % poly (styrene-co-tert-butyl acrylate). Polymeric particles had a particle size of 102 nm and where 10 wt % styrene and 90 wt % acrylate ester. In FIG. 11A, the original wood stain showed significant over-lapping after the “X” mark application. After the poly (styrene-co-tert-butyl acrylate) particles were post-added as an additive, up to 5 wt % solids, no lapping marks were observed (FIG. 11D). This clearly indicates that the poly (styrene-co-tert-butyl acrylate) particle additive has the capability to reduce and eliminate wood stain lapping marks with high efficiency.

As shown in FIGS. 12A-F, to test the lapping elimination capability of polystyrene-co-poly(tert-butyl acrylate) additives/2 wt % tween-20 with different types of resins, a series of water-based wood stain was made with various resins (AC3600, AC3640, AC3699). FIGS. 12A-F illustrate over-lapping tests for: FIG. 12A, stain made by resin AC3600; FIG. 12B, stain made by resin AC3640; FIG. 12C, stain made by resin AC3699; FIG. 12D, stain made by resin AC3600 and post-added 2 wt % tween-20 with 5 wt % polystyrene-co-poly(tert-butyl acrylate); FIG. 12E, stain made by resin AC3640 and post-added 2 wt % tween-20 with 5 wt % polystyrene-co-poly(tert-butyl acrylate); and FIG. 12F, stain made by resin AC3699 and post-added 2 wt % tween-20 with 5 wt % polystyrene-co-poly(tert-butyl acrylate). Particle sizes of all polymeric particles was 102 nm, and polymers were 10 wt % styrene with 90 wt % acrylate ester. In FIGS. 12A-C, stains made with different types of resins all showed lapping marks without post-adding the polystyrene-co-poly(tert-butyl acrylate) additives and tween-20 surfactants. After post-added 5 wt % polystyrene-co-poly(tert-butyl acrylate) additives and 2 wt % tween-20 surfactants, no lapping marks can be observed (FIGS. 12D-F). This clearly indicates that the poly(styrene-co-tert-butyl acrylate) additives and tween-20 surfactants have the capability to reduce and eliminate wood stain lapping marks toward broad types of stains.

As shown in FIGS. 13A-B, to test the lapping elimination capability of poly(styrene-co-tert-butyl acrylate) additives without mixing with tween-20, toward different types of resins, a series of water-based wood stain was made with various resins (AC2763, AC3640). FIGS. 13A-B illustrate over-lapping tests for water-based stains pre-added during the stain formulation process with 5 wt % poly(styrene-co-tert-butyl acrylate): FIG. 13A, stain made by resin AC2736 before and after pre-addition; FIG. 13B, stain made by resin AC3640 before and after pre-addition. In FIGS. 13A-B, stains made with different types of resins all showed lapping marks without pre-added the polystyrene-co-poly(tert-butyl acrylate) additives. Polymeric particles had a particle size of 102 nm, and copolymers were 10 wt % styrene with 90 wt % acrylate. After pre-added polystyrene-co-poly(tert-butyl acrylate) additives by 5% solids during the formulation process, no lapping marks can be observed. This clearly indicates that the poly(styrene-co-tert-butyl acrylate) additives have the capability to reduce and eliminate wood stain lapping marks when pre-added during the stain formulation process.

As shown in FIGS. 14A-D, to test the lapping elimination capability of poly (styrene-co-tert-butyl acrylate) particle additive pre-added with different amounts, water-based wood stain formulated with resin AC 3640 was used as stain matrix. FIGS. 14A-D illustrate over-lapping tests for a water-based wood stain made with resin AC 3640, during the formulation process, pre-added with different amount of poly (styrene-co-tert-butyl acrylate) particles: FIG. 14A, no particles added; FIG. 14B, 1 wt % poly (styrene-co-tert-butyl acrylate);

FIG. 14C, 2.5 wt % poly (styrene-co-tert-butyl acrylate); and FIG. 14D, 5 wt % poly (styrene-co-tert-Butyl acrylate). Polymeric particles had a particle size of 102 nm, and copolymers were 10 wt % styrene and 90 wt % acrylate ester. In FIG. 14A, the original wood stain showed significant over-lapping after the “X” mark application. After the poly (styrene-co-tert-butyl acrylate) particles were pre-added as an additive, up to 5 wt %, no lapping marks were observed (FIGS. 14 B-D). This clearly indicates that the poly (styrene-co-tert-butyl acrylate) particle additive has the capability to reduce and eliminate wood stain lapping marks with high efficiency.

As shown in FIGS. 15A-D, to test the lapping elimination capability of poly (styrene-co-tert-Butyl acrylate) particles on different type of wood substrate (Maple veneer, Red Oak veneer), water-based wood stain formulated with resin AC 3640 was used as stain matrix. FIGS. 15A-D illustrate over-lapped tests for water-based wood stain made with resin AC 3640: FIG. 15A, virgin wood stain tested on maple veneer wood; FIG. 15B, during the formulation process, pre-added with 5 wt % of poly (styrene-co-tert-butyl acrylate) particles with virgin wood stain, tested on maple veneer wood; FIG. 15C, virgin wood stain tested on red oak veneer wood;

FIG. 15D, during the formulation process, pre-added with 5 wt % of poly (styrene-co-tert-butyl acrylate) particles with virgin wood stain, tested on red oak veneer wood. Polymeric particles had a particle size of 102 nm, and copolymers were 10 wt % styrene with 90 wt % acrylate. In FIGS. 15A and C, the original wood stain showed significant over-lapping after the “X” mark application. After the poly (styrene-co-tert-butyl acrylate) particles were pre-added as an additive with 5% by solids, during the formulation process, no lapping marks were observed (FIGS. 15B and D). This clearly indicates that the poly (styrene-co-tert-butyl acrylate) particle additive has the capability to reduce and eliminate wood stain lapping marks on different type of wood substrates.

### Example 3. Synthesis of Nanoparticles with Reduced Particle Size

Nanoparticles were prepared by emulsion polymerization. Typically, in a 5000 mL round-bottom flask, 5-10 g SDS was dissolved in DI water with a total weight of 560 g under mechanical stirring, 200-400 g monomers, and 1-10 g KPS was then added into the flask. The flask was then placed in a heating mantle at 70±1C and 400 rpm of mechanical stirring rate was applied. After polymerization for 1 h the second batch of emulsion was titrated in which contained 10-20 g SDS, 500-1500 ml DI water, monomers, and 5-20 g KPS. A titration pump was used to perform the titration, which took 1 hour to finish. After polymerization for 3 h, the milky emulsion of particle additive was cooled to room temperature. The formed nanoparticles had a particle size in solution of 30 nm-80 nm. The particle size was fine-tuned by adjusting the amount of surfactant and monomers added.

FIG. 16A illustrates a photograph of an emulsion including a particle additive having a particle size of 80 nm, which showed translucent brightness. FIG. 16B illustrates a photograph showing results of an overlapping test for a waterborne wood stain that included the 80 nm particle additive at 5 wt %, showing significant over-lapping elimination after the “X” mark application. This indicates that the size of the particles has a strong impact on the capability to reduce and eliminate wood stain lapping marks. FIG. 16C illustrates a photograph of the emulsion after a 3-week heat aging test at 70° C., showing that the emulsion can remain stable.

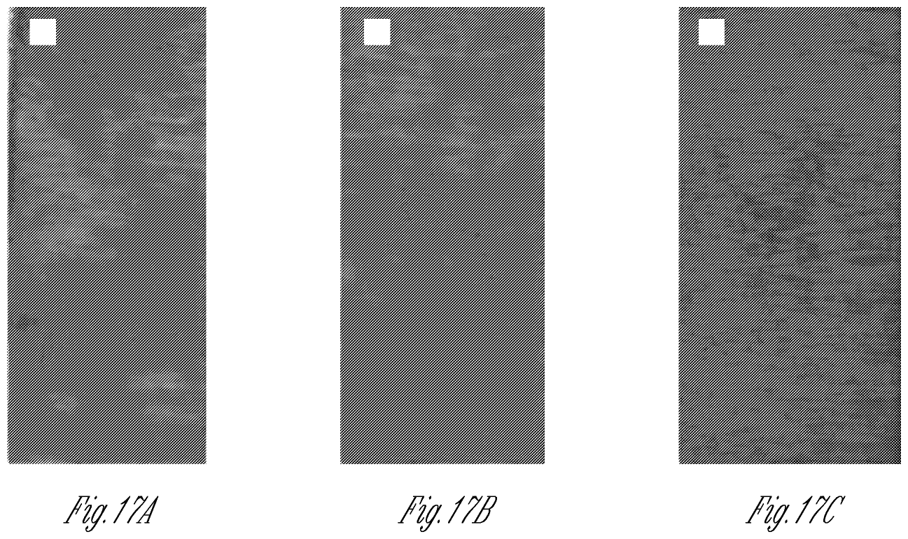

FIGS. 17A-C illustrates overlapping tests for water-based wood stains post-added with 5 wt % particle additives with various particle sizes: FIG. 17A, 35 nm particles; FIG. 17B, 45 nm particles; FIG. 17C, 55 nm particles. In FIG. 17A, particles with 35 nm showed significant over-lapping elimination, after the “X” mark application. As the particles sizes increased with constant chemical composition, the lapping elimination capability stayed constant (FIGS. 17A-17C). This indicates that the 30 nm-80 nm particles, across the entire range of particle sizes, have comparable impact on the capability to reduce and eliminate wood stain lapping marks.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects.

The following exemplary aspects are provided, the numbering of which is not to be construed as designating levels of importance:

Aspect 1 provides an additive for a water-based wood stain, the additive comprising:
a polymeric particle comprising a polymer that comprises a repeating unit formed from a compound having the formula X-L¹-A, wherein X is a substituted or unsubstituted (C₂-C₈)alkenyl containing one or more carbon-carbon double bonds, L¹ is a bond, —C(O)—O—, —O—C(O)—, or a substituted or unsubstituted (C₁-C₁₀)alkylene interrupted by 0, 1, 2, or 3 heteroatoms chosen from O and NR¹ wherein R¹ is —H or (C₁-C₅)alkyl, and A is —H, substituted or unsubstituted (C₁-C₂₀)hydrocarbyl, or substituted or unsubstituted phenyl;
wherein the polymeric particle has a particle size in solution of 10 nm to 2000 nm.

Aspect 2 provides the additive of Aspect 1, wherein the polymeric particle is the polymer.

Aspect 3 provides the additive of any one of Aspects 1-2, wherein the polymeric particle has a particle size in solution of 10 nm to 1,500 nm.

Aspect 4 provides the additive of any one of Aspects 1-3, wherein the polymeric particle has a particle size in solution of 10 nm to 200 nm.

Aspect 5 provides the additive of any one of Aspects 1-4, wherein the polymeric particle has a particle size in solution of 10 nm to 150 nm.

Aspect 6 provides the additive of any one of Aspects 1-5, wherein the polymeric particle is 1 wt % to 60 wt % of the additive.

Aspect 7 provides the additive of any one of Aspects 1-6, wherein the polymeric particle is 10 wt % to 50 wt % of the additive.

Aspect 8 provides the additive of any one of Aspects 1-7, wherein the additive further comprises one or more solvents.

Aspect 9 provides the additive of Aspect 8, wherein the one or more solvents comprise water or a water-miscible solvent.

Aspect 10 provides the additive of any one of Aspects 1-9, wherein X is unsubstituted.

Aspect 11 provides the additive of any one of Aspects 1-10, wherein X is a (C₂-C₄)alkenyl containing a single carbon-carbon double bond.

Aspect 12 provides the additive of any one of Aspects 1-11, wherein X is a vinyl group.

Aspect 13 provides the additive of any one of Aspects 1-12, wherein L¹ is an unsubstituted (C₁-C₁₀)alkylene.

Aspect 14 provides the additive of any one of Aspects 1-13, wherein L¹ is a bond.

Aspect 15 provides the additive of any one of Aspects 1-14, wherein A is an unsubstituted phenyl ring.

Aspect 16 provides the additive of any one of Aspects 1-15, wherein the compound having the formula X-L¹-A is a-methylstyrene, trans-p-methylstyrene, 2-methyl-1-phenyl-1-propene, allylbenzene, 2-methylstyrene, methylstyrene, 4-methylstyrene, or styrene.

Aspect 17 provides the additive of any one of Aspects 1-16, wherein the compound having the formula X-L¹-A is styrene.

Aspect 18 provides the additive of any one of Aspects 1-17, wherein the repeating unit formed from a compound having the formula X-L¹-A is 1 wt % to 100 wt % of the polymer.

Aspect 19 provides the additive of any one of Aspects 1-18, wherein the repeating unit formed from a compound having the formula X-L¹-A is 5 wt % to 50 wt % of the polymer.

Aspect 20 provides the additive of any one of Aspects 1-19, wherein the polymer further comprises a repeating unit formed from a compound having the formula Y-L²-C(O)—O—B or Y-L²-O—C(O)—B, wherein Y is a substituted or unsubstituted (C₂-C₈)alkenyl containing one or more carbon-carbon double bonds, L² is a bond or a substituted or unsubstituted (C₁-C₁₀)alkylene interrupted by 0, 1, 2, or 3 heteroatoms chosen from O and NR¹ wherein R¹ is —H or (C₁-C₅)alkyl, and B is —H or a substituted or unsubstituted (C₁-C₂₀)hydrocarbyl.

Aspect 21 provides the additive of Aspect 20, wherein Y is unsubstituted.

Aspect 22 provides the additive of any one of Aspects 20-21, wherein Y is a (C₂-C₄)alkenyl containing a single carbon-carbon double bond.

Aspect 23 provides the additive of any one of Aspects 20-22, wherein Y is a vinyl group.

Aspect 24 provides the additive of any one of Aspects 20-23, wherein L² is an unsubstituted (C₁-C₁₀)alkylene

Aspect 25 provides the additive of any one of Aspects 20-24, wherein L² is a bond.

Aspect 26 provides the additive of any one of Aspects 20-25, wherein B is —H.

Aspect 27 provides the additive of any one of Aspects 20-26, wherein B is an unsubstituted (C₁-C₂₀)alkyl.

Aspect 28 provides the additive of any one of Aspects 20-27, wherein B is (C₁-C₅)alkyl.

Aspect 29 provides the additive of any one of Aspects 20-28, wherein B is methyl, ethyl, propyl, iso-propyl, butyl, or tert-butyl.

Aspect 30 provides the additive of any one of Aspects 20-29, wherein Y-L²-C(O)—O—B is an alpha, beta-unsaturated ester.

Aspect 31 provides the additive of any one of Aspects 20-30, wherein the compound having the formula Y-L²-C(O)—O—B is tert-butyl methacrylate, sec-butyl methacrylate, benzyl methacrylate, 4-acetoxystyrene, phenyl methacrylate, ethylene glycol phenyl ether methacrylate, butyl methacrylate, 2-ethylhexyl acrylate, acrylic acid, methacrylic acid, acetoacetoxyethyl methacrylate, methacrylic acid, methyl methacrylate, methyl acrylate, ethyl acrylate, butyl acrylate, or tert-butyl acrylate.

Aspect 32 provides the additive of any one of Aspects 20-31, wherein the compound having the formula Y-L²-C(O)—O—B is methyl methacrylate, methacrylate, butylacrylate, or tert-butylacrylate.

Aspect 33 provides the additive of any one of Aspects 20-32, wherein the compound having the formula or Y-L²-O—C(O)—B is vinyl acetate.

Aspect 34 provides the additive of any one of Aspects 20-33, wherein the repeating unit formed from the compound having the formula Y-L²-C(O)—O—B or Y-L²-O—C(O)—B is 1 wt % to 99 wt % of the polymer.

Aspect 35 provides the additive of any one of Aspects 20-34, wherein the repeating unit formed from the compound having the formula Y-L²-C(O)—O—B or Y-L²-O—C(O)—B is 50 wt % to 95 wt % of the polymer.

Aspect 36 provides the additive of any one of Aspects 20-35, wherein the repeating unit formed from the compound having the formula X-L¹-A and the repeating unit formed from the compound having the formula Y-L²-C(O)—O—B or Y-L²-O—C(O)—B have a weight ratio of 0.01:1 to 99:1.

Aspect 37 provides the additive of any one of Aspects 20-36, wherein the repeating unit formed from the compound having the formula X-L¹-A and the repeating unit formed from the compound having the formula Y-L²-C(O)—O—B or Y-L²-O—C(O)—B have a weight ratio of 0.05:1 to 1:1.

Aspect 38 provides the additive of any one of Aspects 20-37, wherein the polymer is saponified after polymerization and wherein the —C(O)—O—B structure in the saponified polymer is —C(O)—O—H or wherein the —O—C(O)—B structure in the saponified polymer is —C—O—H.

Aspect 39 provides the additive of any one of Aspects 1-38, wherein the polymer is poly(styrene-co-(methyl methacrylate)), poly(styrene-co-methacrylate), poly(styrene-co-(butyl acrylate)), poly(styrene-co-(tert-butyl acrylate)), or poly(styrene-co-(vinyl alcohol)).

Aspect 40 provides the additive of any one of Aspects 20-39, wherein the repeating unit formed from a compound having the formula X-L¹-A and the repeating unit formed from a compound having the formula Y-L²-C(O)—O—B or Y-L²-O—C(O)—B forms a hydrophilic lobe of the polymer, wherein the polymer further comprises a crosslinked polymeric hydrophobic lobe that is connected to the polymer in place of the B in the —C(O)—O—B structure or in place of the —C(O)—B in the —O—C(O)—B structure.

Aspect 41 provides the additive of Aspect 40, wherein the crosslinked polymeric hydrophobic lobe comprises repeating units formed from one or more acrylate esters.

Aspect 42 provides the additive of any one of Aspects 40-41, wherein the crosslinked polymeric hydrophobic lobe comprises a repeating unit formed from (C₅-C₃₀)alkyl acrylate and/or (C₅-C₃₀)alkyl methacrylate.

Aspect 43 provides the additive of any one of Aspects 40-42, wherein the crosslinked polymeric hydrophobic lobe comprises a repeating unit formed from (C₁₀-C₂₀)alkyl acrylate and/or (C₁₀-C₂₀)alkyl methacrylate.

Aspect 44 provides the additive of any one of Aspects 40-43, wherein the crosslinked polymeric hydrophobic lobe comprises a repeating unit formed from ethylene glycol dimethacrylate.

Aspect 45 provides the additive of any one of Aspects 40-44, wherein the crosslinked polymeric hydrophobic lobe comprises a repeating unit formed from divinylpyrrolidone.

Aspect 46 provides the additive of any one of Aspects 40-45, wherein the hydrophobic lobe is 10 wt % to 90 wt % of the polymer.

Aspect 47 provides the additive of any one of Aspects 40-46, wherein the hydrophobic lobe is 30 wt % to 70 wt % of the polymer.

Aspect 48 provides the additive of any one of Aspects 40-47, wherein the hydrophilic lobe is 10 wt % to 90 wt % of the polymer.

Aspect 49 provides the additive of any one of Aspects 40-48, wherein the hydrophilic lobe is 30 wt % to 70 wt % of the polymer.

Aspect 50 provides the additive of any one of Aspects 40-49, wherein the particle is a Janus particle.

Aspect 51 provides the additive of any one of Aspects 40-50, wherein the particle is an amphiphilic Janus particle.

Aspect 52 provides the additive of any one of Aspects 40-51, wherein the particle is a self-stratifying Janus particle.

Aspect 53 provides an additive for a water-based wood stain, the additive comprising:
a polymeric particle comprising a polymer that comprises a repeating unit formed from styrene;
wherein the polymeric particle has a particle size in solution of 10 nm to 2000 nm.

Aspect 54 provides an additive for a water-based wood stain, the additive comprising:
a polymeric particle comprising a polymer that is poly(styrene-co-(methyl methacrylate)), poly(styrene-co-methacrylate), poly(styrene-co-(butyl acrylate)), poly(styrene-co-(tert-butyl acrylate)), or poly(styrene-co-(vinyl alcohol));
wherein the polymeric particle has a particle size in solution of 10 nm to 2000 nm.

Aspect 55 provides an additive for a water-based wood stain, the additive comprising:
a polymeric particle comprising a polymer that comprises
   a hydrophilic lobe comprising
      a repeating unit formed from styrene, and
      a repeating unit formed from a compound having the formula Y-L²-C(O)—O—B or Y-L²-O—C(O)—B, wherein Y is a substituted or unsubstituted (C₂-C₈)alkenyl containing one or more carbon-carbon double bonds, L² is a bond or a substituted or unsubstituted (C₁-C₁₀)alkylene interrupted by 0, 1, 2, or 3 heteroatoms chosen from O and NR¹ wherein R¹ is —H or (C₁-C₅)alkyl, and B is —H or a substituted or unsubstituted (C₁-C₂₀)hydrocarbyl, and
   a crosslinked polymeric hydrophobic lobe that is connected to the polymer in place of the B in the —C(O)—O—B structure or in place of the —C(O)—B in the —O—C(O)—B structure, the hydrophobic lobe comprising repeating units formed from one or more acrylate esters; and
wherein the polymeric particle has a particle size in solution of 10 nm to 2000 nm.

Aspect 56 provides a cured and/or dried product of the additive of any one of Aspects 1-55.

Aspect 57 provides a water-based wood stain comprising the additive of any one of Aspects 1-55.

Aspect 58 provides the water-based wood stain of Aspect 57, wherein a concentration of the polymeric particles in the water-based wood stain is 0.1 wt % to 20 wt %.

Aspect 59 provides the water-based wood stain of any one of Aspects 57-58, wherein a concentration of the polymeric particles in the water-based wood stain is 1 wt % to 10 wt %.

Aspect 60 provides the water-based wood stain of any one of Aspects 57-59, wherein a concentration of the polymeric particles in the water-based wood stain is 2 wt % to 5 wt %.

Aspect 61 provides the water-based wood stain of any one of Aspects 57-60, wherein at least 50 wt % of the water-based wood stain is water.

Aspect 62 provides the water-based wood stain of any one of Aspects 57-61, comprising one or more water-based binders.

Aspect 63 provides the water-based wood stain of Aspect 62, wherein the one or more water-based binders comprise an acrylic resin, epoxy resin, alkyd resin, polyester resin, polyurethane resin, waterborne lattices, waterborne electrophoretic deposition resins, waterborne hybrid resins, or a combination thereof.

Aspect 64 provides the water-based wood stain of any one of Aspects 62-63, wherein the one or more water-based binders are 1 wt % to 30 wt % of the water-based stain.

Aspect 65 provides the water-based wood stain of any one of Aspects 62-64, wherein the one or more water-based binders are 1 wt % to 10 wt % of the water-based stain.

Aspect 66 provides a water-based wood stain comprising:
the additive of any one of Aspects 1-55, wherein the polymeric particles have a concentration in the water-based stain of 1 wt % to 30 wt %; and
a water-based binder.

Aspect 67 provides a method of making the water-based wood stain of any one of Aspects 57-66, the method comprising:
combining the additive of any one of Aspects 1-55 and a base water-based stain to form the water-based wood stain.

Aspect 68 provides a method of making the additive of any one of Aspects 1-55, the method comprising:
heating a reaction mixture to form the additive, the reaction mixture comprising
   a free-radical initiator, and
   at least one monomer comprising a vinyl group.

Aspect 69 provides the method of Aspect 68, wherein heating the reaction mixture comprises emulsion polymerization.

Aspect 70 provides the method of any one of Aspects 68-69, wherein the free-radical initiator comprises potassium persulfate, 2,2′-azobis(isobutyronitrile) (AIBN), or a combination thereof.

Aspect 71 provides the method of any one of Aspects 68-79, wherein the reaction mixture further comprises a surfactant.

Aspect 72 provides the method of Aspect 71, wherein the surfactant comprises sodium dodecyl sulfate.

Aspect 73 provides the method of any one of Aspects 68-72, wherein the reaction mixture further comprises a solvent.

Aspect 74 provides the method of Aspect 73, wherein the solvent comprises ethanol.

Aspect 75 provides the method of any one of Aspects 68-74, wherein the monomer comprises α-methylstyrene, trans-β-methylstyrene, 2-methyl-1-phenyl-1-propene, allylbenzene, 2-methylstyrene, methylstyrene, 4-methylstyrene, styrene, tert-butyl acrylate, tert-butyl methacrylate, sec-butyl methacrylate, benzyl methacrylate, 4-acetoxystyrene, phenyl methacrylate, ethylene glycol phenyl ether methacrylate, butyl methacrylate, 2-ethylhexyl acrylate, acrylic acid, methacrylic acid, acetoacetoxyethyl methacrylate, methacrylic acid, methyl methacrylate, methyl acrylate, ethyl acrylate, butyl acrylate, tert-butyl acrylate, or a combination thereof.

Aspect 76 provides the method of any one of Aspects 68-75, further comprising separating the additive from the reaction mixture.

Aspect 77 provides the method of Aspect 76, wherein the separating comprises centrifugation.

Aspect 78 provide the method of any one of Aspects 68-77, further comprising deoxygenating the reaction mixture before and/or during the heating.

Aspect 79 provides the method of Aspect 78, wherein deoxygenating the reaction mixture comprises bubbling an inert gas through the reaction mixture.

Aspect 80 provides the method of any one of Aspects 68-79, wherein the reaction mixture comprises a portion of the free-radical initiator, wherein the method further comprises titrating an additional portion of the free-radical initiator into the reaction mixture during the heating of the reaction mixture.

Aspect 81 provides the method of any one of Aspects 68-80, wherein the reaction mixture comprises a portion of the at least one monomer, wherein the method further comprises titrating an additional portion of the at least one monomer into the reaction mixture during the heating of the reaction mixture.

Aspect 82 provides the method of any one of Aspects 68-81, wherein the additive has a particle size in solution of 10 nm to 2000 nm.

Aspect 83 provides the method of any one of Aspects 68-82, wherein the additive has a particle size in solution of 10 nm to 100 nm.

Aspect 84 provides the method of any one of Aspects 68-83, wherein the additive has a particle size in solution of 30 nm to 80 nm.

Aspect 85 provides a method of making the additive of any one of Aspects 1-55, the method comprising:
heating a reaction mixture to form the additive, the reaction mixture comprising
   a free-radical initiator, and
   at least one monomer comprising a vinyl group;
wherein the heating comprises
   titrating an additional portion of the free-radical initiator into the reaction mixture,
   titrating an additional portion of the at least one monomer comprising a vinyl group into the reaction mixture, or
   a combination thereof; and
wherein the additive has a particle size of 10 nm to 100 nm.

Aspect 86 provides an article comprising wood, the wood comprising the water-based stain of any one of Aspects 57-66 or a dried and/or cured product thereof.

Aspect 87 provides a method of using the additive of any one of Aspects 1-55, the method comprising:
combining the additive with a water-based stain.

Aspect 88 provides the method of Aspect 87, further comprising staining wood with the water-based stain that comprises the additive.

Aspect 89 provides a method of using the water-based wood stain of any one of Aspects 57-66, the method comprising:
applying the water-based stain to wood.

Aspect 90 provides the method of Aspect 89, wherein the wood comprises oak, maple, pine, birch, cherry, cedar, walnut, beech, mahogany, mango, acacia, Mindi, ash, teak, or a combination thereof.

Aspect 91 provides the method of Aspect 89, wherein the wood comprises oak or maple.

Aspect 92 provides the method of any one of Aspects 89-91, further comprising at least partially drying the water-based stain on the wood.

Aspect 93 provides the method of Aspect 92, further comprising applying the water-based stain on top of the at least partially dried water-based stain on the wood.

Aspect 94 provides the additive, water-based stain, method, or article of any one or any combination of Aspects 1-93 optionally configured such that all elements or options recited are available to use or select from.

What is claimed is:

1. An additive for a water-based wood stain, the additive comprising:
a polymeric particle comprising a polymer that comprises a repeating unit formed from a compound having the formula X-L¹-A, wherein X is a substituted or unsubstituted (C₂-C₈)alkenyl containing one or more carbon-carbon double bonds, L¹ is a bond, —C(O)—O—, —O—C(O)—, or a substituted or unsubstituted (C₁-C₁₀)alkylene interrupted by 0, 1, 2, or 3 heteroatoms chosen from O and NR¹ wherein R¹ is —H or (C₁-C₅)alkyl, and A is —H, substituted or unsubstituted (C₁-C₂₀)hydrocarbyl, or substituted or unsubstituted phenyl;
wherein the polymeric particle has a particle size in solution of 10 nm to 2000 nm.

2. The additive of claim 1, wherein the polymeric particle has a particle size in solution of 10 nm to 200 nm.

3. The additive of claim 1, wherein the polymeric particle is 10 wt % to 50 wt % of the additive, wherein the additive further comprises water and/or one or more water-miscible solvents.

4. The additive of claim 1, wherein the compound having the formula X-L¹-A is styrene.

5. The additive of claim 1, wherein the polymer further comprises a repeating unit formed from a compound having the formula Y-L²-C(O)—O—B or Y-L²-O—C(O)—B, wherein Y is a substituted or unsubstituted (C₂-C₈)alkenyl containing one or more carbon-carbon double bonds, L² is a bond or a substituted or unsubstituted (C₁-C₁₀)alkylene interrupted by 0, 1, 2, or 3 heteroatoms chosen from O and NR¹ wherein R¹ is —H or (C₁-C₅)alkyl, and B is —H or a substituted or unsubstituted (C₁-C₂₀)hydrocarbyl.

6. The additive of claim 5, wherein the compound having the formula Y-L²-C(O)—O—B is vinyl acetate, methyl methacrylate, methacrylate, butylacrylate, or tert-butylacrylate.

7. The additive of claim 5, wherein the polymer is saponified after polymerization and wherein the —C(O)—O—B structure in the saponified polymer is —C(O)—O—H or wherein the —O—C(O)—B structure in the saponified polymer is —C—O—H.

8. The additive of claim 5, wherein the repeating unit formed from a compound having the formula X-L¹-A and the repeating unit formed from a compound having the formula Y-L²-C(O)—O—B or Y-L²-O—C(O)—B forms a hydrophilic lobe of the polymer, wherein the polymer further comprises a crosslinked polymeric hydrophobic lobe that is connected to the polymer in place of the B in the —C(O)—O—B structure or in place of the —C(O)—B in the —O—C(O)—B structure, wherein the crosslinked polymeric hydrophobic lobe comprises repeating units formed from one or more acrylate esters.

9. The additive of claim 1, wherein the polymer is poly(styrene-co-(methyl methacrylate)), poly(styrene-co-methacrylate), poly(styrene-co-(butyl acrylate)), poly(styrene-co-(tert-butyl acrylate)), or poly(styrene-co-(vinyl alcohol)).

10. An additive for a water-based wood stain, the additive comprising:
a polymeric particle comprising
a polymer that comprises a repeating unit formed from styrene, and/or
a polymer that is poly(styrene-co-(methyl methacrylate)), poly(styrene-co-methacrylate), poly(styrene-co-(butyl acrylate)), poly(styrene-co-(tert-butyl acrylate)), or poly(styrene-co-(vinyl alcohol));
wherein the polymeric particle has a particle size in solution of 10 nm to 2000 nm.

11. An additive for a water-based wood stain, the additive comprising:
a polymeric particle comprising a polymer that comprises
a hydrophilic lobe comprising
a repeating unit formed from styrene, and
a repeating unit formed from a compound having the formula Y-L²-C(O)—O—B or Y-L²-O—C(O)—B, wherein Y is a substituted or unsubstituted (C₂-C₈)alkenyl containing one or more carbon-carbon double bonds, L² is a bond or a substituted or unsubstituted (C₁-C₁₀)alkylene interrupted by 0, 1, 2, or 3 heteroatoms chosen from O and NR¹ wherein R¹ is —H or (C₁-C₅)alkyl, and B is —H or a substituted or unsubstituted (C₁-C₂₀)hydrocarbyl, and
a crosslinked polymeric hydrophobic lobe that is connected to the polymer in place of the B in the —C(O)—O—B structure or in place of the —C(O)—B in the —O—C(O)—B structure, the hydrophobic lobe comprising repeating units formed from one or more acrylate esters; and
wherein the polymeric particle has a particle size in solution of 10 nm to 2000 nm.

12. A cured and/or dried product of the additive of claim 1.

13. A water-based wood stain comprising the additive of claim 1.

14. The water-based wood stain of claim 13, wherein a concentration of the polymeric particles in the water-based wood stain is 1 wt % to 30 wt %.

15. The water-based wood stain of claim 13, comprising one or more water-based binders.

16. A method of making a water-based wood stain, the method comprising:
combining the additive of claim 1 and a base water-based stain to form the water-based wood stain.

17. An article comprising wood, the wood comprising the water-based stain of claim 13 or a dried and/or cured product thereof.

18. A method of making the additive of claim 1, the method comprising:
heating a reaction mixture to form the additive, the reaction mixture comprising
a free-radical initiator, and
at least one monomer comprising a vinyl group.

19. A method of using the additive of claim 1, the method comprising:
combining the additive with a water-based stain.

20. A method of using the water-based wood stain of claim 13, the method comprising:
applying the water-based stain to wood.
